(19) United States
(12) Patent Application Publication
(10) Pub. No.: US 2023/0297710 A1
(43) Pub. Date: Sep. 21, 2023

(54) Applications in a Multi-User Environment

(71) Applicant: Apple Inc., Cupertino, CA (US)

(72) Inventors: Luis R. Deliz Centeno, Oakland, CA (US); Joseph P. Cerra, San Francisco, CA (US)

(21) Appl. No.: 18/188,803

(22) Filed: Mar. 23, 2023

Related U.S. Application Data
(63) Continuation of application No. PCT/US2021/049863, filed on Sep. 10, 2021.
(60) Provisional application No. 63/082,657, filed on Sep. 24, 2020.

(51) Int. Cl. G06F 21/62; H04L 65/401

(52) U.S. Cl. CPC G06F 21/6218; G06F 21/629; H04L 65/401

(57) ABSTRACT

The disclosure pertains to techniques for collaborating in a multiuser communications environment. One such technique comprises receiving a request from a first device to launch an application in a multiuser communication session with a second device, wherein the request includes an indication of data to be made available in the multiuser communication session and providing the multiuser version of the application to the first device based on the data, wherein the multiuser version of the application provides access to the indicated data, and wherein the multiuser version of the application provides shared functionality between the first device and the second device.

### BACKGROUND

This disclosure relates generally to multiuser environments. More particularly, but not by way of limitation, this disclosure relates to techniques related to hosting an application in an extended reality (XR) environment.

Some devices are capable of generating and presenting XR environments (XRE). An XRE may include a wholly or partially simulated environment that people sense and/or interact with via an electronic system. In an XRE, a subset of a person's physical motions, or representations thereof, are tracked, and, in response, one or more characteristics of one or more virtual objects simulated in the XRE are adjusted in a manner that comports with at least one law of physics. Some XREs allow multiple users to interact with each other within the XRE. However, what is needed is a technique to host applications in an XRE while managing the private information of users.

### BRIEF DESCRIPTION OF THE DRAWINGS

FIG. 1 shows, in block diagram form, a simplified system diagram according to one or more embodiments.

FIG. 2 shows a diagram of example operating environments, according to one or more embodiments.

FIG. 3 is a line drawing illustrating an interface for sharing content to the XRE, in accordance with aspects of the present disclosure.

FIG. 4 is a diagram illustrating an XR communication (XRC) session displayed on a display, in accordance with aspects of the present disclosure.

FIG. 5 is a diagram illustrating shared browsing, in accordance with aspects of the present disclosure.

FIG. 6 is a diagram illustrating a shared experience, in accordance with aspects of the present disclosure.

FIG. 7 is a flowchart illustrating technique for interacting with an XR computing environment (XRCE) application in an XRC session, in accordance with aspects of the present disclosure.

FIGS. 8A and 8B show exemplary systems for use in various XR technologies in accordance with one or more embodiments.

### DETAILED DESCRIPTION

This disclosure pertains to techniques for users collaborating within an extended reality environment (XRE) to share content items, such as pictures, videos, sounds, etc., without the privacy concerns raised by, for example, handing your phone to another person. These content items may be accessed using an application. This application is capable of being executed both outside and within the context of the XRE. The application is capable of executing in a particular way based on whether the application is executing in the XRE or outside of the XRE. A sharing user may be able to select certain content items for sharing and present the selected content items to other users in the XRE in the application executing in the context of the XRE. The application offers a different set of features based on how the application is being executed. For example, the application, when run in the context of the XRE, may only allow access to the selected content items, whereas when the application is run outside of the context of the XRE, the application allows access to additional content items.

A person can interact with and/or sense a physical environment or physical world without the aid of an electronic device. A physical environment can include physical features, such as a physical object or surface. An example of a physical environment is physical forest that includes physical plants and animals. A person can directly sense and/or interact with a physical environment through various means, such as hearing, sight, taste, touch, and smell. In contrast, a person can use an electronic device to interact with and/or sense an XRE that is wholly or partially simulated. The XR environment can include mixed reality (MR) content, augmented reality (AR) content, virtual reality (VR) content, and/or the like. With an XR system, some of a person's physical motions, or representations thereof, can be tracked, and, in response, characteristics of virtual objects simulated in the XR environment can be adjusted in a manner that complies with at least one law of physics. For instance, the XR system can detect the movement of a user's head and adjust graphical content and auditory content presented to the user similar to how such views and sounds would change in a physical environment. In another example, the XR system can detect movement of an electronic device that presents the XR environment (e.g., a mobile phone, tablet, laptop, or the like) and adjust graphical content and auditory content presented to the user similar to how such views and sounds would change in a physical environment. In some situations, the XR system can adjust characteristic(s) of graphical content in response to other inputs, such as a representation of a physical motion (e.g., a vocal command).

Many different types of electronic systems can enable a user to interact with and/or sense an XR environment. A nonexclusive list of examples include heads-up displays (HUDs), head-mountable systems, projection-based systems, windows or vehicle windshields having integrated display capability, displays formed as lenses to be placed on users' eyes (e.g., contact lenses), headphones/earphones, input systems with or without haptic feedback (e.g., wearable or handheld controllers), speaker arrays, smartphones, tablets, and desktop/laptop computers. A head-mountable system can have one or more speaker(s) and an opaque display. Other head-mountable systems can be configured to accept an opaque external display (e.g., a smartphone). The head-mountable system can include one or more image sensors to capture images/video of the physical environment and/or one or more microphones to capture audio of the physical environment. A head-mountable system may have a transparent or translucent display, rather than an opaque display. The transparent or translucent display can have a medium through which light is directed to a user's eyes. The display may utilize various display technologies, such as uLEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users' retinas. Projection systems can also project virtual objects into the physical environment (e.g., as a hologram or onto a physical surface).

For purposes of this disclosure, an XRC session refers to an XRE in which two or more devices are participating.

For purposes of this disclosure, a local XRC device refers to a current device being described or being controlled by a user being described in an XRC session.

For purposes of this disclosure, colocated XRC devices refer to two devices that share a physical environment and an XRC session, such that the users of the colocated devices may experience the same physical objects and XR objects.

For purposes of this disclosure, a remote XRC device refers to a second device that is located in a separate physical environment from a current, local XRC device. In one or more embodiments, the remote XRC device may be a participant in the XRC session.

For purposes of this disclosure, shared virtual elements refer to XR objects that are visible or otherwise able to be experienced in an XRE by participants in an XRC session.

For purposes of this disclosure, an XRCE refers to a computing environment or container of an XRC session capable of hosting applications. The XRCE enables applications to run within an XRC session. In certain cases, the XRCE may enable users of the XRC session to interact with hosted applications within the XRC session.

For the purposes of this disclosure, an XRCE instance refers to an XRCE of a current device being described or being controlled by a user being described. The XRCE instance can allow the user to participate in an XRC session and run an application in the XRC session.

For the purposes of this disclosure, a second XRCE instance refers to an XRCE of a secondary device or a secondary device being controlled by a second user in the XRC session, other than the local XRCE instance. The second XRCE instance may be remote or colocated.

For the purposes of this disclosure, an XRCE application refers to an application which is capable of executing within the context of an XRCE.

For the purposes of this disclosure, a second XRCE application refers to an XRCE application of a secondary device or a secondary device being controlled by the second user in the XRC session, other than the local XRCE instance. The second XRCE application may be remote or colocated.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developer's specific goals (e.g., compliance with system- and business-related constraints) and that these goals may vary from one implementation to another. It will also be appreciated that such development efforts might be complex and time consuming but would nevertheless be a routine undertaking for those of ordinary skill in the design and implementation of graphics modeling systems having the benefit of this disclosure.

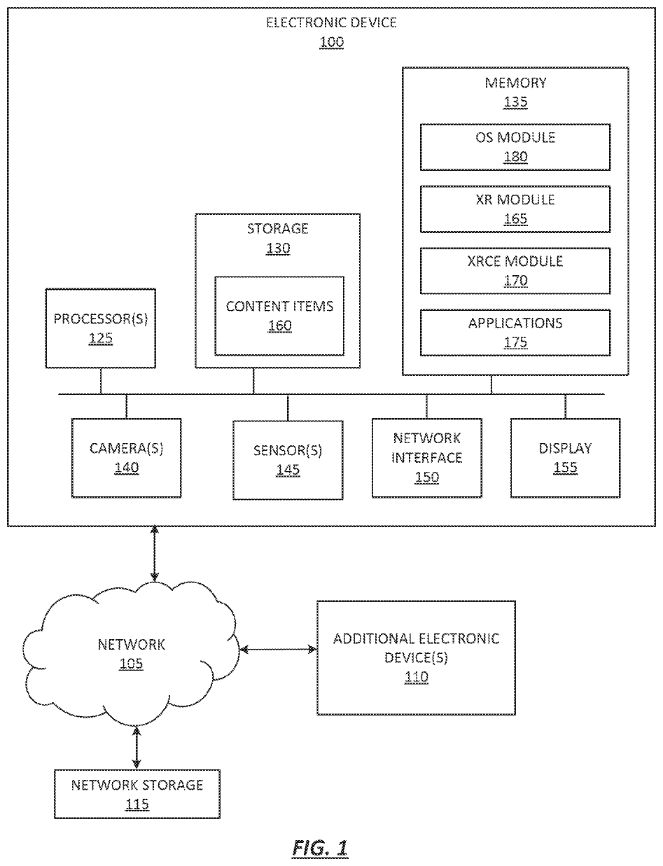

Referring to FIG. 1, a simplified block diagram of an electronic device 100 is depicted, communicably connected to additional electronic devices 110 and a network storage 115 over a network 105, in accordance with one or more embodiments of the disclosure. Electronic device 100 may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. Electronic device 100, additional electronic device 110, and/or network storage 115 may additionally, or alternatively, include one or more additional devices within which the various functionality may be contained or across which the various functionality may be distributed, such as server devices, base stations, accessory devices, and the like. Illustrative networks, such as network 105 include, but are not limited to, a local network such as a universal serial bus (USB) network, an organization's local area network, or a wide area network (WAN) such as the Internet. According to one or more embodiments, electronic device 100 is utilized to participate in an XRC session. It should be understood that the various components and functionality within electronic device 100, additional electronic device 110 and network storage 115 may be differently distributed across the devices or may be distributed across additional devices. The electronic device 100 may include a network interface 150, which interfaces with networking components, such as radio, infrared, and/or visible light transceivers for communicating with other devices. The network interface 150 may interface with either wired or wireless networking components, or both.

Electronic device 100 may include one or more processors 125, such as a central processing unit (CPU). Processor(s) 125 may include a system-on-chip such as those found in mobile devices and include one or more dedicated graphics processing units (GPUs). Further, processor(s) 125 may include multiple processors of the same or different type. Electronic device 100 may also include a memory 135. Memory 135 may include one or more different types of memory, which may be used for performing device functions in conjunction with processor(s) 125. For example, memory 135 may include cache, ROM, RAM, or any kind of transitory or non-transitory computer-readable storage medium capable of storing computer-readable code. Memory 135 may store various programming modules for execution by processor(s) 125, including XR module 165, XRCE module 170, and other various applications 175.

The memory 135 may also include an OS module 180, for supporting basic functionality and managing hardware of the XR electronic device 100. The OS module 180 provides an environment in which applications 175 may execute within. The XRCE module 170 and XR module 165 may run within the context of the OS module 180, in certain cases. In other cases, XRCE module 170 and XR module 165 may handle basic functionally and manage hardware of the XR electronic device 100 in parallel with, or in place of, the OS module 180. The XRCE module 170 also provides an environment in which applications 175 may execute within. Applications 175 may include, for example, computer applications that may be experienced in a XRC session by multiple devices, such as XR electronic device 100 and additional XR electronic devices 110.

Electronic device 100 may also include storage 130. Storage 130 may include one more non-transitory computer-readable mediums, including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Storage 130 may be configured to store content items 160, according to one or more embodiments.

Electronic device 100 may also include one or more cameras 140 or other sensors 145, such as a depth sensor, from which depth of a scene may be determined. In one or more embodiments, each of the one or more cameras 140 may be a traditional RGB camera or a depth camera. Further, cameras 140 may include a stereo camera or other multicamera system, a time-of-flight camera system, or the like. Electronic device 100 may also include a display 155. The display device 155 may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

According to one or more embodiments, memory 135 may include one or more modules that comprise computer-readable code executable by the processor(s) 125 to perform functions. The memory modules may include, for example, an XR module 165 which may be used to provide an XRE for a local XRC device. An XRCE module 170 may generate an environment supporting the XR environment. For example, the XRCE module 170 may provide services and/or application programming interfaces that may be used by the XR environment and/or hosted applications to interface with the operating system (OS) and/or hardware of the electronic device 100. The XRC session may be a computing environment which supports a shared experience by electronic device 100 as well as additional electronic devices 110.

The memory 135 may also include an OS module 180, for supporting basic functionality and managing hardware of the electronic device 100. The OS module 180 provides an environment in which applications 175 may execute within. The XRCE module 170 and XR module 165 may run within the context of the OS module 180 in certain cases. In other cases, XRCE module 170 and XR module 165 may handle basic functionally and manage hardware of the electronic device 100 in parallel with or in place of the OS module 180. The XRCE module 170 also provides an environment in which applications 175 may execute within. Applications 175 may include, for example, computer applications that may be experienced in an XRC session by multiple devices, such as electronic device 100 and additional electronic devices 110.

Although electronic device 100 is depicted as comprising the numerous components described above, in one or more embodiments, the various components may be distributed across multiple devices. Accordingly, although certain calls and transmissions are described herein with respect to the particular systems as depicted, in one or more embodiments, the various calls and transmissions may be made differently directed based on the differently distributed functionality. Further, additional components may be used, and some combination of the functionality of any of the components may be combined.

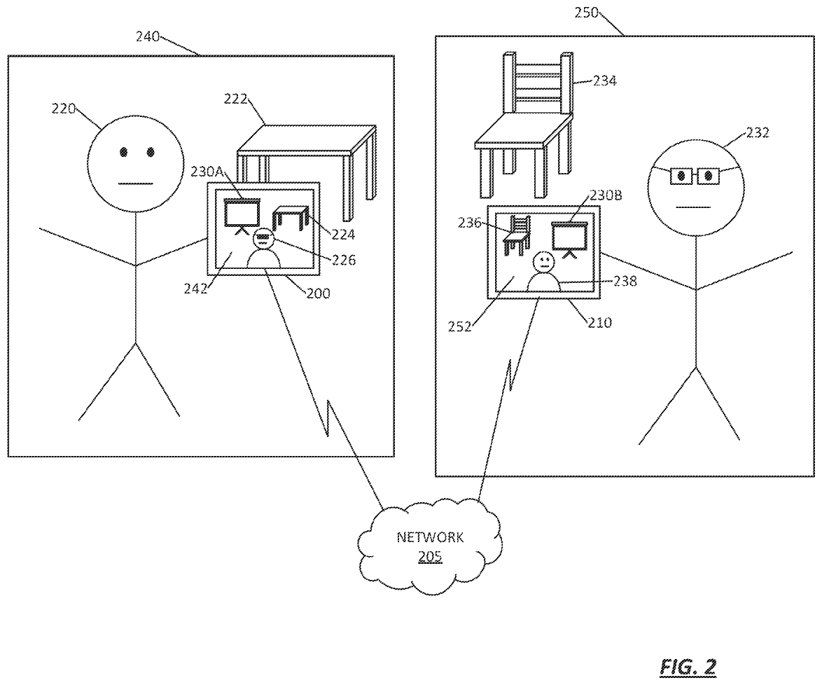

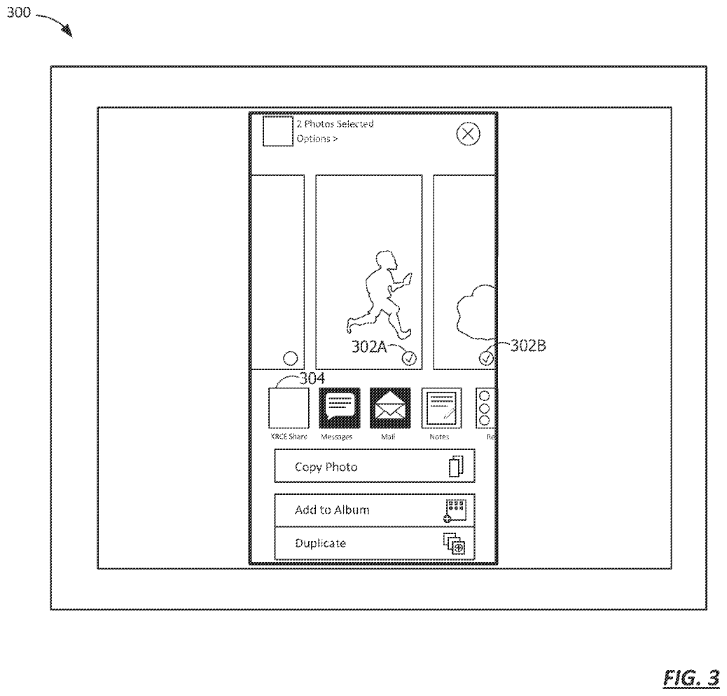

FIG. 2 shows a diagram of example operating environments, according to one or more embodiments. While pertinent features are shown, those of ordinary skill in the art will appreciate from the present disclosure that various other features have not been illustrated for the sake of brevity and so as not to obscure more pertinent aspects of the example among implementations disclosed herein. To that end, as a nonlimiting example, the operating environment 240 includes a first physical environment, whereas operating environment 250 includes a second physical environment.

As shown in FIG. 2, the first environment 240 includes a first user 220 that is utilizing a first electronic device 200, and the second environment 250 includes a second user 232 that is utilizing a second electronic device 210. In one or more embodiments, the first electronic device 200 and the second electronic device 210 include mobile devices, such as handheld devices, wearable devices, and the like.

In one or more embodiments, the first electronic device 200 and the second electronic device 210 communicate with each other via a network 205. Examples of network 205 may include, for example, the Internet, a WAN, a local area network (LAN), etc. In one or more embodiments, the first electronic device 200 and the second electronic device 210 may be participating in an XRC session.

Although electronic device 200 and second electronic device 210 may be participating in the common XRC session, the virtual environment may be rendered differently on each device. As shown, the electronic device 200 may depict physical objects of the environment 240. As shown, physical table 222 may be depicted on the display 242 as a virtual table 224. In one or more embodiments, the display 242 may be a pass-through display, and virtual table 224 may simply be a view of physical table 222 through display 242.

Display 242 of electronic device 200 may also include an avatar 226 corresponding to user 232 in physical environment 250. For purposes of this disclosure, an avatar may include a virtual representation of a user. The avatar may depict real-time actions of the corresponding user 232, including movement, updated location, and/or interactions with various physical components and/or virtual components within the XRC session. An avatar may or may not mimic physical characteristics of the user and may or may not mimic facial expressions of the user.

According to one or more embodiments, an XRCE may be an XRE that supports one or more XRCE applications or other modules which provide depictions of XR objects across all participating devices, such as electronic device 200 and second electronic device 210. As shown in display 242, presentation panel 230A is an example of a virtual object which may be visible to all participating devices.

As an example, returning to environment 250, second electronic device 210 includes a display 252, on which the presentation panel virtual object 230B is depicted. It should be understood that in one or more embodiments, although the same virtual object may be visible across all participating devices, the virtual object may be rendered differently according to the location of the electronic device, the orientation of the electronic device, or other physical or virtual characteristics associated with electronic devices 200 and 210 and/or the XRCE depicted within displays 242 and 252.

Returning to environment 250, another characteristic of an XRC session is that while virtual objects may be shared across participating devices, physical worlds may appear differently. As such, physical chair 234 is depicted as virtual chair 236. As described above, and in one or more embodiments, display 252 may be a pass-through display, and virtual chair 236 may be a view of physical chair 234 through the pass-through display 252. In addition, electronic device 210 depicts an avatar 238 corresponding to user 220 within physical environment 240.

According to one or more embodiments, the virtual objects, such as presentation panels 230A and 230B, may be rendered in conjunction with an XRCE application. In one or more embodiments, multiple XRCE applications may be executed within an XRCE. For example, the XRCE can host XRCE applications within the virtual environment of the XRCE as virtual objects. As discussed further below, an application may be configured to be run either within or outside of an XRCE. For example, an application may include multiple operating modes based on an operating environment, or context, in which the application is executing, for example, an XRCE mode, and a non-XRCE mode. It may be determined that the application is running within the context of the XRCE, such as through an application programming interface (API), and operate in the XRCE mode. The application, when run outside of the XRCE, may run in the non-XRCE mode. For example, when run in the context of an OS of the electronic device, rather than the XRCE, the application runs in the non-XRCE mode. As used herein, the XRCE application or hosted application may also refer to an application running in XRCE mode as well as an application that is solely configured to run within the context of an XRCE. The XRCE may provide a container or computing environment in which an XRCE application may run in a manner similar to an operating system. These containers may be presented to the user as virtual objects, such that the XRCE application appears to be executing in a window, on a surface, or another virtual object.

In certain cases, the XRCE applications are executed in the context of a specific XRCE instance. For example, a first user, associated with a first device, may be participating in an XRC session with a second user, associated with a second device. The XRCE application in this example executes on both the first and second device. Based on input from the first user, the first device may execute a first XRCE application hosted in a local XRCE instance. The first XRCE application may share data with a second XRCE application hosted in a second XRCE instance executing on a second device. Executing an XRCE application within a context of a specific XRCE instance helps provide a measure of privacy for the local user within the XRCE. In certain cases, XRCE instances may be executed in local devices. In other cases, XRCE instances may execute, at least in part, on a network or hosted device.

In certain cases, users of the XRCE may share content from XRCE applications with other users. Examples of content include images, video, audio, documents, spreadsheets, presentations, and the like. According to one or more embodiments, the one or more XRCE applications executing within the XRCE may share content between the participants of the XRC session. For example, a first user may use an XRCE application to share their content, such as photos, videos, music, etc., with other users active in the XRC session, such as a second device.

Allowing content from a user to be shared with other users raises privacy concerns. For example, just because a user is sharing their photos does not mean they want to share all of their photos. The XRCE application may offer reduced functionality, or more limited functionality with respect to certain features, as compared to a non-XRCE version of the application, for example, to help maintain privacy of the user sharing content. For example, the XRCE application may be instantiated based on a user-designated set of shared content and may be restricted from accessing content aside from this designated set of shared content. The XRCE application may display this designated set of shared content in the XRC session. Additionally, certain features that the application includes when executing outside of the XRCE context, such as those for editing content displayed in the application, creating content, selecting other content, etc., may not be available or disabled when the application is executed within the XRCE. It may be understood that as used herein, the XRCE application may present nonvisual content either with or without a visual component. For example, the shared content may be an audio clip, and this content may be presented in the XRC session by playing back the audio clip. This audio clip may be displayed by itself, or there may be an accompanying visual indication or component.

While the XRCE version of the application described above includes certain features that offer reduced functionality as compared to a non-XRCE version of the application, it may be understood that functionality offered by the XRCE version of the application may vary. For example, the functionality of the XRCE version of the application may vary for every user. In certain cases, the user sharing the content may have a different set of features available than another user. The XRCE version of the application of the other user may restrict browsing of other content, either of the sharing user or of the other user. In certain cases, the XRCE version of the application of the sharing user may include more functionality than the XRCE version of the application for the other user. For example, the XRCE version of the application of the sharing user may include substantially all of the features of the non-XRCE version, while the XRCE version of the application for the other users may have limited functionality. In certain cases, the other user may see a representation of the XRCE version of the application, for example, if they do not have the application.

FIG. 3 is a line drawing illustrating an interface for sharing content 300 to the XRCE, in accordance with aspects of the present disclosure. In this example, the interface for sharing content 300 is initially executing outside of the context of the XRCE. As an example, a user may be browsing content on their device using an application and accessing the interface for sharing content 300, for example, by using a button, long press, or otherwise selecting a content item. In certain cases, the user may then select one or more content items for sharing, for example, by placing a check 302A and 302B on the images selected for sharing with an XRC session. The user may then indicate that the selected content items may be shared to the XRC session, for example, using an XRCE sharing button 304.

In certain cases, the XRCE instance may be running, for example, as a background application. For example, the first user may switch out of an active XRCE instance and into another application to browse for and/or select content to share in the XRC session. In certain cases, the user may task switch from the XRCE instance into an operating system environment and select another application, such as a media player application, to access. As another example, the user may task switch from the XRCE instance into an operating system environment and select one or more media items, which are then opened in the other application. In other cases, there may not be a running XRCE instance, and selecting content to share to an XRC session, for example, by using the XRCE sharing button 304, may initiate an XRC session. In other cases, the XRCE may include a browse or search functionality, which may help a user locate and/or share media items within the XRCE. In certain cases, an application may be accessed from within the XRC session by a user without the application being visible to other users of the XRC session.

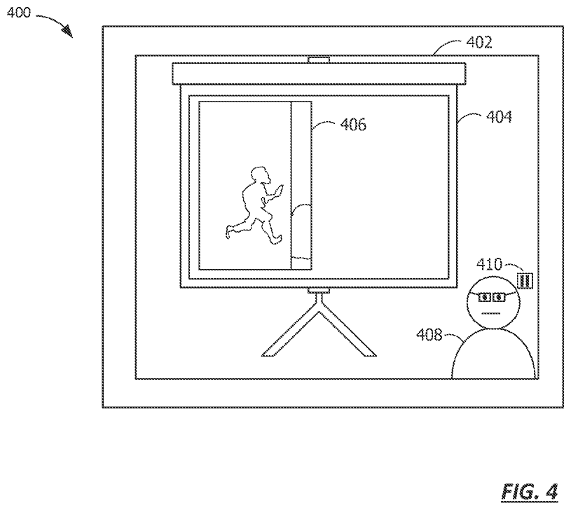

FIG. 4 is a diagram illustrating an XR environment of an XRC session displayed on a display 400, in accordance with aspects of the present disclosure. In this example, the XRCE application is hosted within the XRCE instance 402, and the XRCE application is displayed in presentation panel 404. In certain cases, users may want to access content within the XRC session without necessarily sharing the content with other users of the XRC session. Content which is shared with other users may be presented in a context which indicates that the content is shared. For example, when selected media items are to be shared with other users, an XRCE application associated with the selected media items may be launched within the XRCE instance. For example, a media viewer may be instantiated in the XRCE instance, displaying an indication that the content within the media view is shared. In this example, the XRCE application displays within a presentation panel 404, indicating that the media items within the presentation panel 404 is shared with other users. In certain cases, the XRCE application may display the presentation panel 404. In other cases, the presentation panel 404 may be provided by the XRCE to indicate that content within the presentation panel 404 is shared content.

The XRCE instance may include functionality that XRCE applications may integrate with. For example, the XRCE instance may help provide a framework for networking, synchronization, communication paths, shared data, etc. accessible to XRCE applications. The XRCE instance may host an application, having shared content within the presentation panel 404. As an example, when sharing content, an indication of the content to be shared may be passed to the XRCE instance, such as by calling into a content-sharing API. An XRCE application may be instantiated based on the shared content such that the XRCE application is able to access the shared content but does not access other content that may be on the device. The XRCE instance may display the XRCE application, such as a first XRCE application, within the presentation panel 404, which may help indicate to the user that the content is shared with other users of the XRC session. The XRCE instance or XRC session may transmit a representation of the shared content to other users of the XRC session. For example, the content data may be sent to other users, or the content data may be reencoded, compressed, transformed, encapsulated, etc. prior to being sent to other users. Once received by the other users, such as a second device of a second user, the XRCE instance of the second device may instantiate a second XRCE application stored on the second device based on the content data being shared within the context of the XRC. The content shared by the first user may be displayed by the second XRCE application in a corresponding presentation panel in the XRCE instance of the second user. In certain cases, the second XRCE application may be different than the first XRCE application. For example, the second user may use a different XRCE application to access a type of content being shared.

The XRCE application displaying shared content may have different functionality as compared to another application instance which does not display shared content, such as a non-XRCE version of the application. For example, the XRCE application displaying shared content may only have access to the shared content; the browse and save functionalities may not be available, editing functionality may not be available, and the like. In this example, the two shared images 406 are accessible to the XRCE application. In certain cases, where a first user shares content, the content may be transmitted to a second device participating in the XRC session. A corresponding XRCE application associated with the second device may then access the shared content and display the shared content to the second user.

In certain cases, a second user 408 in the XRC session may also share content to the XRC session. In this example, the second user 408 may temporarily leave or disengage with the XRC session to select additional content to share. In this example, the second user 408 is associated with the second device executing a second XRCE instance, linked to the XRC session. The XRCE instance may display an icon 410 associated with the second user 408 indicating that the second user 408 has switched focus from the XRC session or has directed their attention elsewhere. Examples of switching focus or directing attention away from the XRC session may include switching to another application without exiting the XRC session, interacting with another application or other object in the second XRCE instance that is not visible in the XRC session, and/or when interacting with menus or other user interface (UI) elements of the second XRCE instance. Once the second user 408 has selected additional content to share, the selected additional content may be transmitted to the other users in the XRC session. The additional content may then be displayed in the presentation panel 404 of the respective XRCE instances. In certain cases, the additional content may be added to the content accessible to the XRCE application and displayed by the XRCE application. In other cases, another instance of the XRCE application may be instantiated based on the additional content and added to the presentation panel 404 and the additional content displayed by the other instance of the XRCE application. In other cases, another XRCE application may be instantiated based on the additional content and added to the presentation panel 404 and the additional content displayed by the other XRCE application. In certain cases, the additional content may be displayed in another presentation panel in a manner similar to that discussed above. In certain cases, the additional content may be displayed in the respective XRCE instances without being presented in a presentation panel in a manner similar to that discussed above.

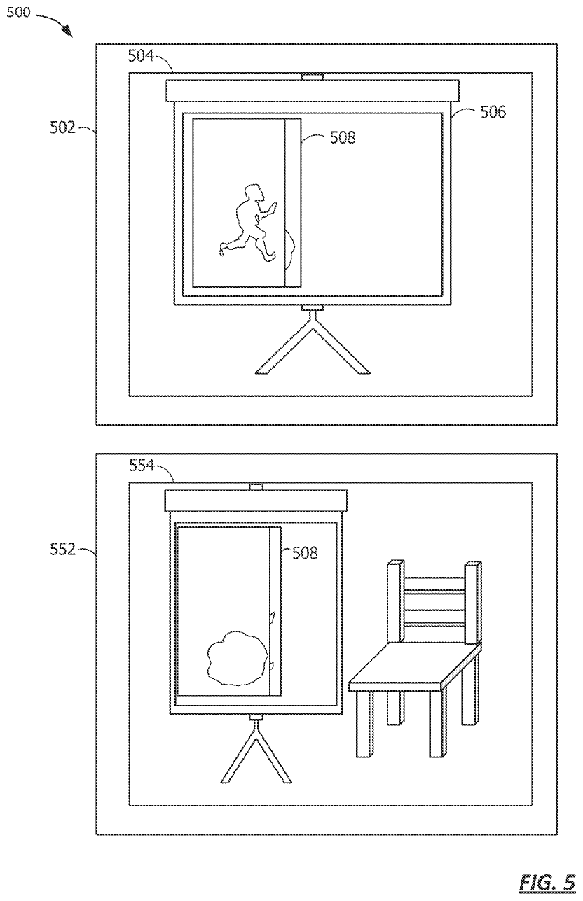

In certain cases, the XRCE application may also offer additional functionality to help facilitate the sharing experience. FIG. 5 is a diagram illustrating shared browsing 500, in accordance with aspects of the present disclosure. As shown, this example of shared browsing 500 includes a first device 502 associated with a first user running a first XRCE instance 504 and a second device 552 associated with a second user running a second XRCE instance 554. The first XRCE instance 504 and the second XRCE instance 554 are participating in an XRC session and provide different views into an XRC session. The first XRCE instance 504 includes a first presentation panel 506. In this example, the first presentation panel 506 includes shared images 508 shared by the first user to the XRC session. In certain cases, each user of the XRC session may be able to browse the shared images 508 independently. For example, a first image of the shared images 508 may be displayed to the first user in the first presentation panel 506 in the first XRCE instance 504, and the second user may browse through the shared images 508, here causing a second image of the shared images 508 to be displayed without causing the images in the first presentation panel 506 to be changed. In certain cases, it may be desirable to provide a level of control over the shared content being displayed in the XRC session.

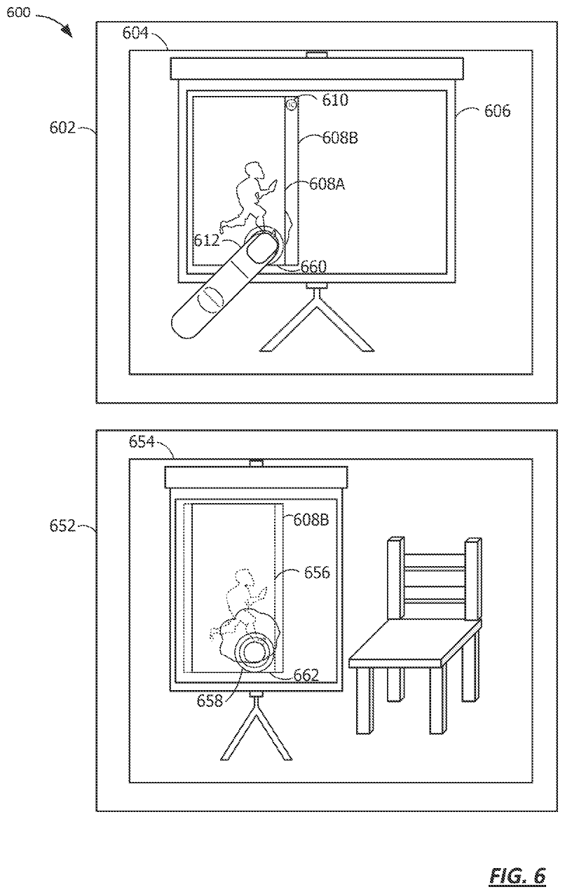

FIG. 6 is a diagram illustrating a shared experience 600, in accordance with aspects of the present disclosure. As before, this example of shared experience 600 includes a first device 602 associated with a first user running a first XRCE instance 604 and a second device 652 associated with a second user running a second XRCE instance 654. The first XRCE instance 604 and the second XRCE instance 654 are participating in an XRC session and provide different views into the XRC session. In certain cases, the XRCE application may allow the user sharing the content to control the shared content visible to other users in the presentation panel 606. For example, the XRCE application or the presentation panel 606 may include multiple modes with respect to the shared content. These modes may be set or selected among in a variety of ways, such as via UI elements, gestures, or based on touches or other types of input. One such mode may cause images displayed in the respective XRCE instances of the users to be synchronized. For example, second set of images 662 displayed in the second XRCE instance 654 may be synchronized with first set of images 660 displayed in the first XRCE instance 604. In certain cases, where the content displayed in the presentation panel 606 is synchronized or updated for users of the XRC session, the XRCE application or the presentation panel 606 may transmit an indication of which image is to be displayed in the presentation panel 606 to the users in their respective XRCE instances. This indication may be sent, for example, via an XRCE framework handling communication and data synchronization for the XRC session. In certain cases, control as to the shared content displayed may be passed between users of the XRC session.

In certain cases, users may be able to obtain information regarding access to shared content. In this example, the first XRCE instance 604 of the first user is displaying a first image 608A of the second set of images 662 (e.g., a shared version of the first set of images 660). At the second XRCE instance 654, the second user may browse the second set of images 662 and display a second image 608B. The first user may receive a browse indication 610 that another user is viewing another image of the shared images 608. In certain cases, the browse indication 610 may further include information about which other users are browsing the shared images and/or indicate which shared images are being viewed by other users.

In certain cases, images may be partially synchronized for users of the XRC session. In this example, the first XRCE instance 604 of the first user displays the first image 608A of the shared images and the second XRCE instance 654 is displaying the second image 608B. In certain cases, partial synchronization may be initiated, for example, by the first user. Initiation of partial synchronization may be based on, for example, interaction by a presenting user, such as the first user, with the shared content. For example, the first user may interact with the shared content by touching 612 the first image 608A. In certain cases, the presenting user may be the user to which other users are partially synchronized with and the presenting user may not be the user sharing the shared content. Other examples of interacting with shared content may include gestures, attention tracking, user interface elements such as buttons, toggles, etc. Where the second XRCE instance 654 is displaying a different part of the shared content, for example, if the second user is browsed to and/or interacting with the second image 608B, a presentation indication 656 of which portion of the shared content the presenting user is interacting with may be displayed by the second XRCE instance 654 without completely overriding the portion of the shared content the second user is browsed to and/or interacting with. In certain cases, the presentation indication 656 may be a partially transparent or overlaid version of the portion of the shared content the presenting user is interacting with. The second user may be able to continue browsing and/or interacting with the shared content. In certain cases, an interaction indication 658 may be displayed to users other than the presenting user. The interaction indication 658 may be based on all interactions or particular interactions by the presenting user with the shared content. For example, a particular gesture, such as hard touch, double touch, swipe, etc., may cause the interaction indication 658 by the presenting user to be shared with other users, while other gestures, such as a light touch, multi-finger swipe, etc., may not cause the interaction indication 658. The interaction indication 658 may be provided so a user can call attention or emphasize one or more portions of the shared content.

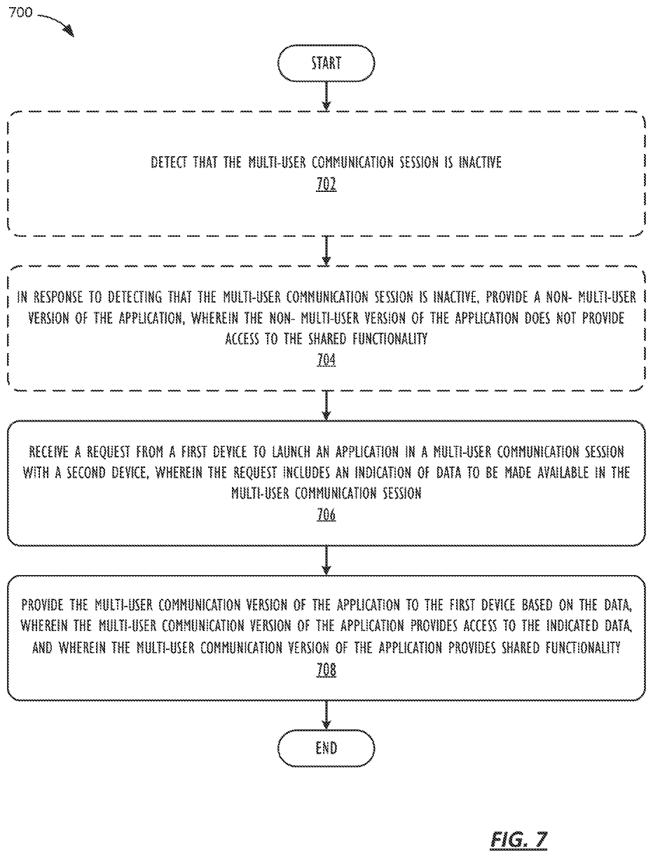

FIG. 7 is a flowchart illustrating technique for interacting with an XRCE application in an XRC session, in accordance with aspects of the present disclosure. Optionally, at block 702, the multiuser communication session is detected as inactive. For example, multiple users may be collaborating in an XRC session, and a first user may select a set of content to share in the XRC session. The first user may deactivate an XRCE instance on the first device and start the XRCE application. The XRCE application may detect that the XRCE application is not being executed in the context of an XRCE, for example, based on a flag or an API call. Optionally, at block 704, a non-multiuser version of the application may be provided in response to detecting that the multiuser communication session is inactive, where the non-multiuser version of the application does not provide access to shared functionality. For example, a determination may be made that the XRCE instance is not active, for example, by the XRCE application or the device, and the non-XRCE version (e.g., regular version) of the application is provided. This regular version of the application may lack certain functionality that is available in the XRCE version, such as restricting editing or deleting content by other users or collaboration and presentation functionality. At block 706, a request is received from a first user at a first device to launch an application in an XRC session with a second user at a second device, wherein the request includes an indication of data to be made available in the XRC session. For example, the regular version of the application may include functionality to allow content to be selected for sharing to an XRC session. Content may be selected, for example, within the application to be made available to the XRC session.

In some cases, the request may be received from a non-multiuser version of the application. For example, a user of a device may use the regular version of the application to select content for sharing to an XRC session. The regular version of the application may invoke, either directly, or via the XRC session/instance, the XRCE application based on the selected content. In some cases, the multiuser version of the application comprises an application separate from the non-multiuser version. For example, the regular version of the application may be a separate application from the XRCE application and the XRCE application may be started, for example, by the XRC instance. In some cases, the multiuser version of the application comprises an interface provided by the non-multiuser version of the application, wherein the interface of the multiuser version of the application is separate from an interface of the non-multiuser version. For example, the regular version of the application may include a user interface that is displayed when the application is executed regularly (e.g., not in the context of an XRC instance) as well as a separate version user interface that is displayed when the application is executed in the context of an XRC instance. In some cases, the multiuser version of the application comprises the same application and interface as the non-multiuser version of the application, and wherein the multiuser version of the application includes certain functionality that is not available in the non-multi-user version of the application. For example, the regular version of the application may include a user interface that is displayed when the application is executed regularly (e.g., not in the context of an XRC instance) and aspects of that user interface may be used when the is executed in the context of an XRC instance. Some functionality may be available when the application is executed in the context of the XRC session and this functionality may not be available when the application is executed regularly. In some cases, the multiuser version of the application comprises the same application and interface as the non-multiuser version of the application, and wherein the multiuser version of the application restricts certain functionality that is available in the non-multi-user version of the application. For example, the regular version of the application may include a user interface that is displayed when the application is executed regularly (e.g., not in the context of an XRC instance) and aspects of that user interface may be used when the is executed in the context of an XRC instance. Some functionality that may be available in the regular version of the application may not be available when the application is executed in the context of the XRC session.

At block 708, the XRCE version of the application is provided to the first device based on the data, wherein the XRCE version of the application provides access to the indicated data, and wherein the XRCE version of the application provides shared functionality between the first device and the second device. For example, an XRCE version or mode of the application may be launched and hosted within the XRCE instance executing on the first device with access to the selected content. As a more detailed example, selecting content to be made available within the XRC session may start an instance of the application with an API call, a set flag, or other indicator, which causes the XRCE application to be launched. The XRCE application can access the selected content for display in the XRC session. In certain cases, the XRCE application may be displayed in a portion of the XRC session designated for shared content, such as a particular virtual or physical surface. The XRCE application may be restricted from accessing other content, such as content stored on the first device, aside from the selected content. The XRCE application executing in context of the XRCE instance may have a subset of the features the first application would have when the application is executing outside of the XRCE instance. For example, features for editing or creating content may be unavailable or disabled in the XRCE application. In certain cases, data based on the shared set of content may be transmitted to a second device associated with the XRC session for display to a second user of the second device. In certain cases, the second device may display this data using a second XRCE application. The XRCE application and the second XRCE application may be different instances of the same application or different applications. The second XRCE application may be hosted in a second XRCE instance executing on the second device. In certain cases, a same portion of the data may be displayed on both the first and second devices. In certain cases, the shared functionality includes tools to allow the first and second devices to interact with the data in a manner that is visible to the first and second users. For example, a scroll command received by the first device may cause the displayed data to scroll on both the first and second devices. In another example, an interaction, such as a touch or swipe, may be received from the first user by the XRCE application. An indication of this interaction may be transmitted to the second device and presented by the second XRCE application, such as by surfacing the touch via an icon, marker, or other symbol. In certain cases, the first user may interact with the shared set of content and an indication of this interaction may be transmitted to the second device. This indication of the interaction may then be displayed by the second device in the second XRCE instance running on the second device.

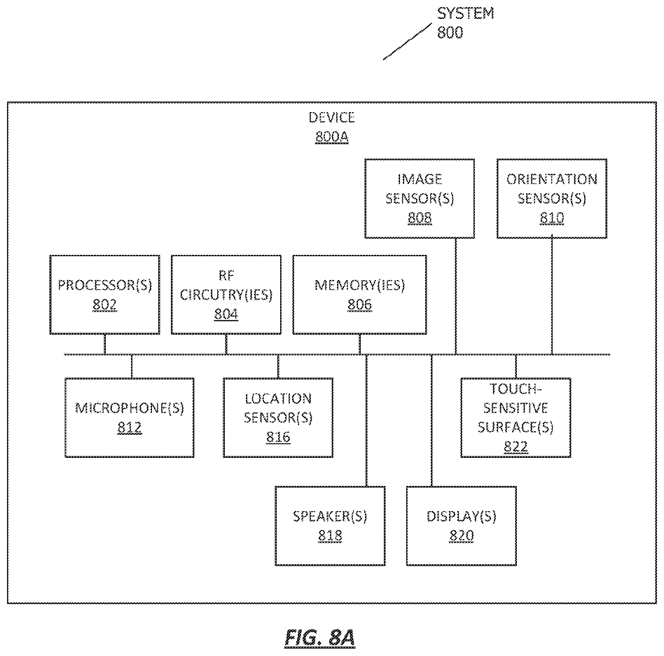

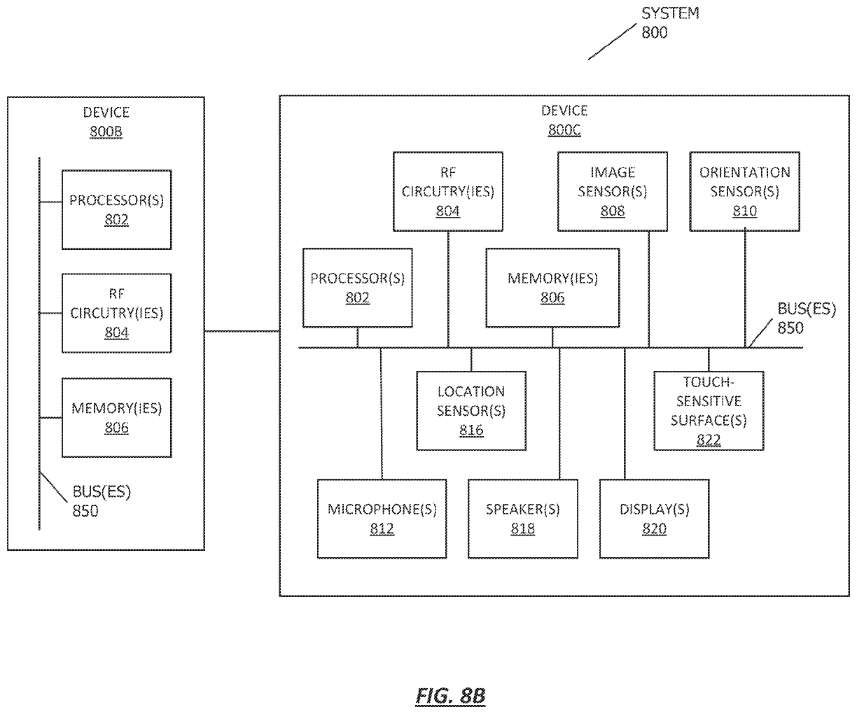

FIG. 8A and FIG. 8B depict exemplary system 800 for use in various XR technologies.

In some examples, as illustrated in FIG. 8A, system 800 includes device 800A. Device 800A includes various components, such as processor(s) 802, RF circuitry(ies) 804, memory(ies) 806, image sensor(s) 808, orientation sensor(s) 810, microphone(s) 812, location sensor(s) 816, speaker(s) 818, display(s) 820, and touch-sensitive surface(s) 822. These components optionally communicate over communication bus(es) 850 of device 800A.

In some examples, elements of system 800 are implemented in a base station device (e.g., a computing device, such as a remote server, mobile device, or laptop) and other elements of system 800 are implemented in a second device (e.g., a head-mounted device). In some examples, device 800A is implemented in a base station device or a second device.

As illustrated in FIG. 8B, in some examples, system 800 includes two (or more) devices in communication, such as through a wired connection or a wireless connection. First device 800B (e.g., a base station device) includes processor(s) 802, RF circuitry(ies) 804, and memory(ies) 806. These components optionally communicate over communication bus(es) 850 of device 800B. Second device 800C (e.g., a head-mounted device) includes various components, such as processor(s) 802, RF circuitry(ies) 804, memory(ies) 806, image sensor(s) 808, orientation sensor(s) 810, microphone(s) 812, location sensor(s) 816, speaker(s) 818, display(s) 820, and touch-sensitive surface(s) 822. These components optionally communicate over communication bus(es) 850 of device 800C.

System 800 includes processor(s) 802 and memory(ies) 806. Processor(s) 802 include one or more general processors, one or more graphics processors, and/or one or more digital signal processors. In some examples, memory(ies) 806 are one or more non-transitory computer-readable storage mediums (e.g., flash memory, random access memory) that store computer-readable instructions configured to be executed by processor(s) 802 to perform the techniques described below.

System 800 includes RF circuitry(ies) 804. RF circuitry(ies) 804 optionally include circuitry for communicating with electronic devices, networks such as the Internet, intranets, and/or a wireless network such as cellular networks and wireless local area networks (LANs). RF circuitry(ies) 804 optionally includes circuitry for communicating using near-field communication and/or short-range communication, such as Bluetooth®.

System 800 includes display(s) 820. Display(s) 820 may have an opaque display. Display(s) 820 may have a transparent or semitransparent display that may incorporate a substrate through which light representative of images is directed to an individual's eyes. Display(s) 820 may incorporate LEDs, OLEDs, a digital light projector, a laser scanning light source, liquid crystal on silicon, or any combination of these technologies. The substrate through which the light is transmitted may be a light waveguide, optical combiner, optical reflector, holographic substrate, or any combination of these substrates. In one example, the transparent or semitransparent display may transition selectively between an opaque state and a transparent or semitransparent state. Other examples of display(s) 820 include heads-up displays, automotive windshields with the ability to display graphics, windows with the ability to display graphics, lenses with the ability to display graphics, tablets, smartphones, and desktop or laptop computers. Alternatively, system 800 may be designed to receive an external display (e.g., a smartphone). In some examples, system 800 is a projection-based system that uses retinal projection to project images onto an individual's retina or projects virtual objects into a physical setting (e.g., onto a physical surface or as a holograph).

In some examples, system 800 includes touch-sensitive surface(s) 822 for receiving user inputs, such as tap inputs and swipe inputs. In some examples, display(s) 820 and touch-sensitive surface(s) 822 form touch-sensitive display(s).

System 800 includes image sensor(s) 808. Image sensors(s) 808 optionally include one or more visible light image sensor, such as charged coupled device (CCD) sensors, and/or complementary metal-oxide-semiconductor (CMOS) sensors operable to obtain images of physical elements from the physical setting. Image sensor(s) also optionally include one or more infrared (IR) sensor(s), such as a passive IR sensor or an active IR sensor, for detecting infrared light from the physical setting. For example, an active IR sensor includes an IR emitter, such as an IR dot emitter, for emitting infrared light into the physical setting. Image sensor(s) 808 also optionally include one or more event camera(s) configured to capture movement of physical elements in the physical setting. Image sensor(s) 808 also optionally include one or more depth sensor(s) configured to detect the distance of physical elements from system 800. In some examples, system 800 uses CCD sensors, event cameras, and depth sensors in combination to detect the physical setting around system 800. In some examples, image sensor(s) 808 include a first image sensor and a second image sensor. The first image sensor and the second image sensor are optionally configured to capture images of physical elements in the physical setting from two distinct perspectives. In some examples, system 800 uses image sensor(s) 808 to receive user inputs, such as hand gestures. In some examples, system 800 uses image sensor(s) 808 to detect the position and orientation of system 800 and/or display(s) 820 in the physical setting. For example, system 800 uses image sensor(s) 808 to track the position and orientation of display(s) 820 relative to one or more fixed elements in the physical setting.

In some examples, system 800 includes microphones(s) 812. System 800 uses microphone(s) 812 to detect sound from the user and/or the physical setting of the user. In some examples, microphone(s) 812 includes an array of microphones (including a plurality of microphones) that optionally operate in tandem, such as to identify ambient noise or to locate the source of sound in space of the physical setting.

System 800 includes orientation sensor(s) 810 for detecting orientation and/or movement of system 800 and/or display(s) 820. For example, system 800 uses orientation sensor(s) 810 to track changes in the position and/or orientation of system 800 and/or display(s) 820, such as with respect to physical elements in the physical setting. Orientation sensor(s) 810 optionally include one or more gyroscopes and/or one or more accelerometers.

The techniques defined herein consider the option of obtaining and utilizing a user's personal information. For example, one aspect of the present technology is automatically determining whether an application is executing in an XRCE. However, to the extent such personal information is collected, such information should be obtained with the user's informed consent, such that the user has knowledge of and control over the use of their personal information.

Parties having access to personal information will utilize the information only for legitimate and reasonable purposes, and will adhere to privacy policies and practices that are at least in accordance with appropriate laws and regulations. In addition, such policies are to be well-established, user-accessible, and recognized as meeting or exceeding governmental/industry standards. Moreover, the personal information will not be distributed, sold, or otherwise shared outside of any reasonable and legitimate purposes.

Users may, however, limit the degree to which such parties may obtain personal information. The processes and devices described herein may allow settings or other preferences to be altered such that users control access of their personal information. Furthermore, while some features defined herein are described in the context of using personal information, various aspects of these features can be implemented without the need to use such information. As an example, a user's personal information may be obscured or otherwise generalized such that the information does not identify the specific user from which the information was obtained.

It is to be understood that the above description is intended to be illustrative, and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIG. 7 or the arrangement of elements shown in FIGS. 1-6 and 8 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain English equivalents of the respective terms “comprising” and “wherein.”

1. A method for collaborating in a multiuser communication session, comprising:
receiving a request at a first device to launch an application in a multiuser communication session with a second device, wherein the request includes an indication of data to be made available in the multiuser communication session; and
providing a multiuser version of the application to the first device based on the data, wherein the multiuser version of the application provides access to the indicated data, and wherein the multiuser version of the application provides shared functionality between the first device and the second device.

2. The method of claim 1, wherein providing access to the indicated data comprises providing access to the indicated data and restricting access to other data not indicated in the indication of data to be made available.

3. The method of claim 1, further comprising displaying the multiuser version of the application in the multiuser communication session such that the multiuser version of the application is displayed by the first device and a multiuser version of a corresponding application is displayed by the second device.

4. The method of claim 1, wherein providing the multiuser version comprises:
receiving an indication of an interaction to a corresponding multiuser version of the application from the second device; and
updating the multiuser version of the application based on the received indication.

5. The method of claim 1, wherein the shared functionality includes one or more tools to allow the first device and the second device to interact with the data in a manner that is displayable by the first device and the second device.

6. The method of claim 5, wherein the shared functionality further comprises causing a same portion of the data to be displayed on the first device and the second device.

7. The method of claim 1, further comprising:
receiving an interaction with the multiuser version of the application; and
transmitting an indication of the interaction to the second device for presentation at the second device.

8. The method of claim 1, further comprising:
detecting that the multiuser communication session is inactive; and
in response to detecting that the multiuser communication session is inactive, providing a non-multiuser version of the application, wherein the non-multiuser version of the application does not provide access to the shared functionality.

9. The method of claim 1, wherein providing access to the indicated data comprises restricting the second device from editing the indicated data.

10. The method of claim 1, wherein providing access to the indicated data comprises restricting the second device from deleting the indicated data.

11. The method of claim 1, wherein providing the multiuser version of the application comprises providing the multiuser version of the application within the multiuser communication session, and further comprising providing the non-multiuser version of the application to the first device outside of the multiuser communication session.

12. The method of claim 1, further comprising: transmitting a representation of the indicated data to the second device for display by a second multiuser version of an application of the second device, wherein the second multiuser version of the application restricts access to other data of the first device not included in the representation of the indicated data.

13. The method of claim 1, wherein the request is received from a non-multiuser version of the application and wherein the multiuser version of the application comprises an application separate from the non-multiuser version.

14. The method of claim 1, wherein the request is received from a non-multiuser version of the application and wherein the multiuser version of the application comprises an interface provided by the non-multiuser version of the application, wherein the interface of the multiuser version of the application is separate from an interface of the non-multiuser version.

15. The method of claim 1, wherein the request is received from the non-multiuser version of the application and the multiuser version of the application comprises the same application and interface as the non-multiuser version of the application, and wherein the multiuser version of the application includes certain functionality that is not available in the non-multi-user version of the application.

16. The method of claim 1, wherein the request is received from the non-multiuser version of the application and the multiuser version of the application comprises the same application and interface as the non-multiuser version of the application, and wherein the multiuser version of the application restricts certain functionality that is available in the non-multi-user version of the application.

17. A non-transitory program storage device comprising instructions stored thereon to cause one or more processors to:
receive a request at a first device to launch an application in a multiuser communication session with a second device, wherein the request includes an indication of data to be made available in the multiuser communication session; and
provide the multiuser version of the application to the first device based on the data, wherein the multiuser version of the application provides access to the indicated data, wherein the multiuser version of the application provides shared functionality between the first device and the second device.

18. The non-transitory program storage device of claim 17, wherein the instructions further cause the one or more processors to provide access to the indicated data by causing the one or more processors to provide access to the indicated data and restricting access to other data not indicated in the indication of data to be made available.

19. The non-transitory program storage device of claim 17, wherein the instructions further cause the one or more processors to:
display the multiuser version of the application in the multiuser communication session such that the multiuser version of the application is displayed by the first device and a multiuser version of a corresponding application is displayed by the second device.

20. An electronic device, comprising:
a memory; and
one or more processors operatively coupled to the memory, wherein the one or more processors are configured to execute instructions causing the one or more processors to:
receive a request from a first device to launch an application in a multiuser communication session with a second device, wherein the request includes an indication of data to be made available in the multiuser communication session; and
provide the multiuser version of the application to the first device based on the data, wherein the multiuser version of the application provides access to the indicated data, and wherein the multiuser version of the application provides shared functionality between the first device and the second device.
